(19) United States
(12) Patent Application Publication
(10) Pub. No.: US 2002/0102444 A1
(43) Pub. Date: Aug. 1, 2002

(54) Technique and apparatus to control the response of a fuel cell system to load transients

(76) Inventors: Daniel O. Jones, Glenville, NY (US); John Parks, Loudonville, NY (US); Eric White, Guilderland Center, NY (US); Dustan Skidmore, Troy, NY (US)

Correspondence Address: Fred G. Pruner, Jr., TROP, PRUNER & HU, P.C., Ste, 100, 8554 Katy Freeway, Houston, TX, 77024, US

(21) Appl. No.: 09/773,704

(22) Filed: Jan. 31, 2001

(51) Int. Cl. H01M 8/04; H01M 16/00; H02J 7/00

(52) U.S. Cl. 429/13; 429/23; 429/9; 320/101

(57) ABSTRACT

A system includes a first load, a second load, a fuel processor, a fuel cell stack and a circuit. The fuel processor provides a fuel flow, and the fuel cell stack is coupled to the first load and adapted to provide a power in response to the fuel flow. At least some of this power is consumed by the first load. The circuit is adapted to in response to a decrease in the power produced by the fuel cell stack and consumed by the first load, determine whether to route at least some of the power produced by the fuel cell stack and not consumed by the first load to the second load, and based on the determination, selectively route some of the power that is produced by the fuel cell stack to the second load.

### BACKGROUND

The invention generally relates to a technique and apparatus to control response of a fuel cell system to load transients.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:

H₂→2H⁺+2e⁻ at the anode of the cell, and

O₂+4H⁺+4e⁻→2H₂O at the cathode of the cell.

A typical fuel cell has a terminal voltage near one volt DC. For purposes of producing much larger voltages, multiple fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

A fuel cell system may include a fuel processor that converts a hydrocarbon (natural gas or propane, as examples) into a fuel flow for the fuel cell stack. For a given output power of the fuel cell stack, the fuel flow to the stack must satisfy the appropriate stoichiometric ratios governed by the equations listed above. Thus, a controller of the fuel cell system may determine the appropriate output power from the stack and based on this determination, estimate the fuel flow to satisfy the appropriate stoichiometric ratios. In this manner, the controller regulates the fuel processor to produce this flow, and in response to controller determining that the output power should change, the controller estimates a new rate of fuel flow and controls the fuel processor accordingly.

The fuel cell system may provide power to an external load, such as a load that is formed from residential appliances and electrical devices that may be selectively turned on and off to vary the power that is consumed by the load. Thus, the power that is consumed by the load may not be constant, but rather, the power that is consumed by the load may vary over time and abruptly change in steps. For example, if the fuel cell system provides power to a house, different appliances/electrical devices of the house may be turned on and off at different times to cause the power that is consumed by the load to vary in a stepwise fashion over time.

It is possible that the fuel processor may not be able to adequately adjust its fuel flow output in a timely fashion to respond to a transient in the power that is consumed by the load. As a result, the fuel cell system may oxidize, for example in an external burner, the excess fuel flow from the fuel processor until the fuel flow from the fuel processor decreases to the appropriate level. However, this technique may reduce the overall efficiency of the fuel cell system, and in some cases result in overheating of the burner used to oxidize excess fuel.

Thus, there is a continuing need for an arrangement and/or technique to address one or more of the problems that are stated above.

### SUMMARY

In an embodiment of the invention, a technique that is usable with a fuel cell stack includes providing a fuel flow to the fuel cell stack to produce power. At least some of the power is consumed by a first load. In response to a decrease in the power that is produced by the fuel cell stack and consumed by the first load, the technique includes determining whether to route at least some of the power that is produced by the fuel cell stack and is not consumed by the first load to a second load. Based on the determination, at least some of the power that is produced by the fuel cell stack and is not consumed by the first load is selectively routed to the second load.

Advantages and other features of the invention will become apparent from the following description, drawing and claims.

### BRIEF DESCRIPTION OF THE DRAWING

FIG. 1 is a schematic diagram of a fuel cell system according to an embodiment of the invention.

FIGS. 2 and 3 are flow diagrams depicting operation of the fuel cell system according to different embodiments of the invention.

FIG. 4 depicts an exemplary waveform of a power consumed by a load to the fuel cell system over time.

FIG. 5 depicts an output current of a fuel cell stack of the fuel cell system in response to the power depicted in FIG. 3 according to an embodiment of the invention.

FIG. 6 depicts a charging current of a battery of the fuel cell system in response to the power depicted in FIG. 3 according to an embodiment of the invention.

### DETAILED DESCRIPTION

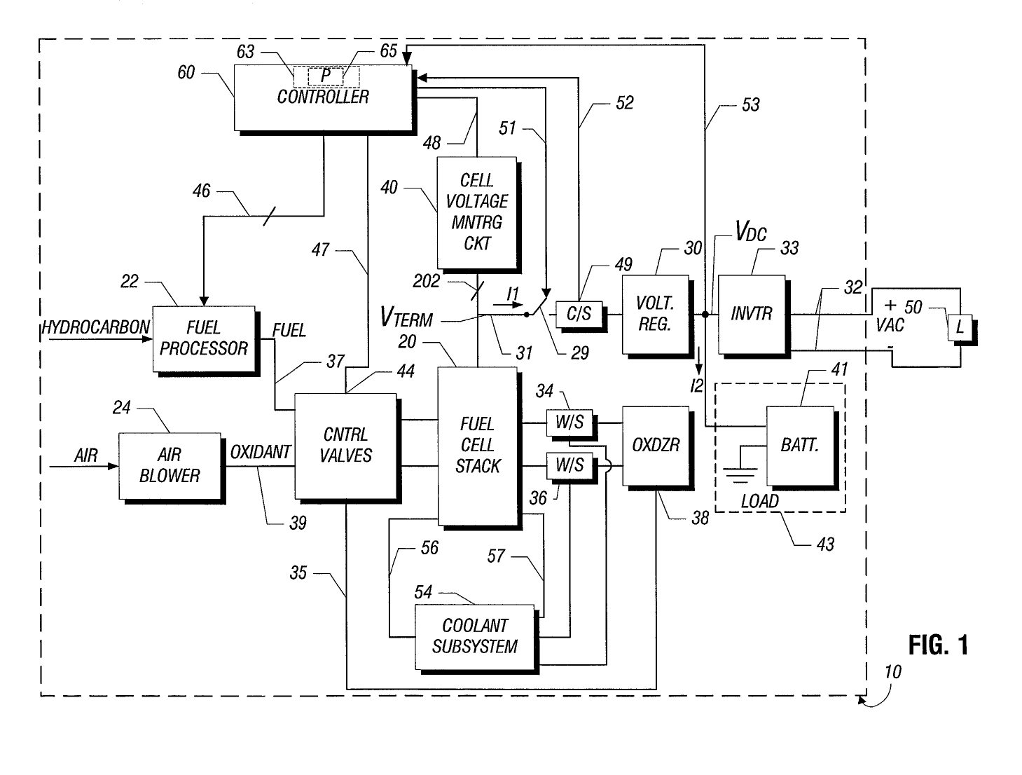

Referring to FIG. 1, an embodiment of a fuel cell system 10 in accordance with the invention includes a fuel cell stack 20 (a PEM-type fuel cell stack, for example) that is capable of producing power for an external load 50 (a residential load, for example) and parasitic elements (fans, valves, etc.) of the system 10 in response to fuel and oxidant flows that are provided by a fuel processor 22 and an air blower 24, respectively. In this manner, the fuel cell system 10 controls the fuel production of the fuel processor 22 to control the fuel flow that is available for electrochemical reactions inside the fuel cell stack 20. This rate of fuel flow to the fuel cell stack 20, in turn, controls the level of power that is produced by the stack 20. Alternatively stated, the fuel cell system 10 controls the level of fuel production by the fuel cell processor 22 to establish a particular output current of the fuel cell stack 20. The output current (and power) is received by the load 50 and the parasitic elements of the fuel cell system 10.

As described below, the fuel cell system 10 bases (at least in part) its regulation of the fuel processor 22 on the power that is consumed (or “demanded”) by the load 50, as the fuel cell system 10, in general, attempts to match the power that is provided by the fuel cell stack 20 with the power that is consumed by the load 50 and the various parasitic elements of the system 10. Otherwise, when too much fuel is produced by the fuel processor 22, excess fuel either passes through the fuel cell stack 20 or bypasses around the stack 20 (via conduit 35) to the oxidizer 38. When the fuel processor 22 does not produce enough fuel, the fuel cell stack 20 does not produce the required power, and stack voltage and cell voltages of the stack 20 may decrease to undesirable levels.

The power that is consumed by the load 50 may vary over time, as the load 50 may represent a collection of individual loads (appliances and/or electrical devices that are associated with a house, for example) that may each be turned on and off. As a result, the power that is consumed by the load 50 may change to produce a transient. In the context of this application, a “transient in the power consumed by the load 50” refers to a significant change in the power (that is consumed by the load 50) that deviates from the current steady state level of the power at the time the transient occurs. The transient may have a time constant that is on the same order or less than the time constant of the fuel processor 22. In the context of the application, the phrase “down transient” refers to a negative transient in the power that is consumed by the load 50, and the phrase “up transient” refers to a positive transient in the power that is consumed by the load 50.

For various reasons, the fuel processor 22 may not respond quickly to a down transient to decrease its fuel output. As examples, the fuel processor 22 may be incapable of rapidly adjusting to transients in the power that is consumed by the load 50 and/or the rate at which the fuel processor 22 decreases its fuel flow output may be limited, for purposes of decreasing the level of carbon monoxide (CO) that is produced by the fuel processor 22 due to a rapid change in the fuel processor's operating point. However, regardless of the reason for the fuel processor 22 not immediately responding to the down transient, after a down transient, a period of time exists in which the fuel processor 22 supplies a fuel flow that is at a level for providing an output current level that is larger than the current that is consumed by the load 50 and the parasitic elements of the system 10. Therefore, a conventional fuel cell system may divert some of this fuel flow to an oxidizer, or flare, to burn off some of the fuel so that the appropriate fuel flow is provided to the fuel cell stack. Otherwise, unconsumed fuel passes through the fuel cell stack to the oxidizer.

However, unlike conventional arrangements, the fuel cell system 10 takes measures, if possible, to not burn off excess fuel. In this manner, the fuel cell system 10 provides all of the fuel flow that is produced by the fuel processor 22 to the fuel cell stack 20 (under certain conditions, described below) during the time interval that follows a down transient and at the same time, the system increases the power that is consumed from the fuel cell stack 20 to cause the stack 20 to consume the additional fuel. In this manner, the fuel cell system 10 adds an additional load 43 onto the fuel cell stack 20 during this time interval to minimize the fuel that is diverted to an oxidizer 38 of the system 10. Thus, this technique enhances the efficiency of the fuel cell system 10.

As an example, in some embodiments of the invention, the load 43 may include a battery 41 that has its output terminals electrically coupled to the fuel cell stack 20 to supplement the power that is provided to the stack 20 after up transients times when the power that is consumed by the load 50 rapidly increases and the fuel cell stack 20 does not provide enough power for the load 50. However, in the time interval after a down transient, the battery 41 may be charged and thus, receive power from the fuel cell stack 20. Therefore, this technique of temporarily increasing the load on the fuel cell stack 20 enhances the overall efficiency of the system 10, as compared to burning off excess fuel. As described below, it is possible that at a given time, the battery 41 may be fully charged and thus, may not capable of receiving power. For this scenario, in some embodiments of the invention, the fuel cell system 10 does not route all of the additional fuel to the stack 20, but rather, the system 10 routes fuel that will not be consumed by the stack 20 to the oxidizer 38.

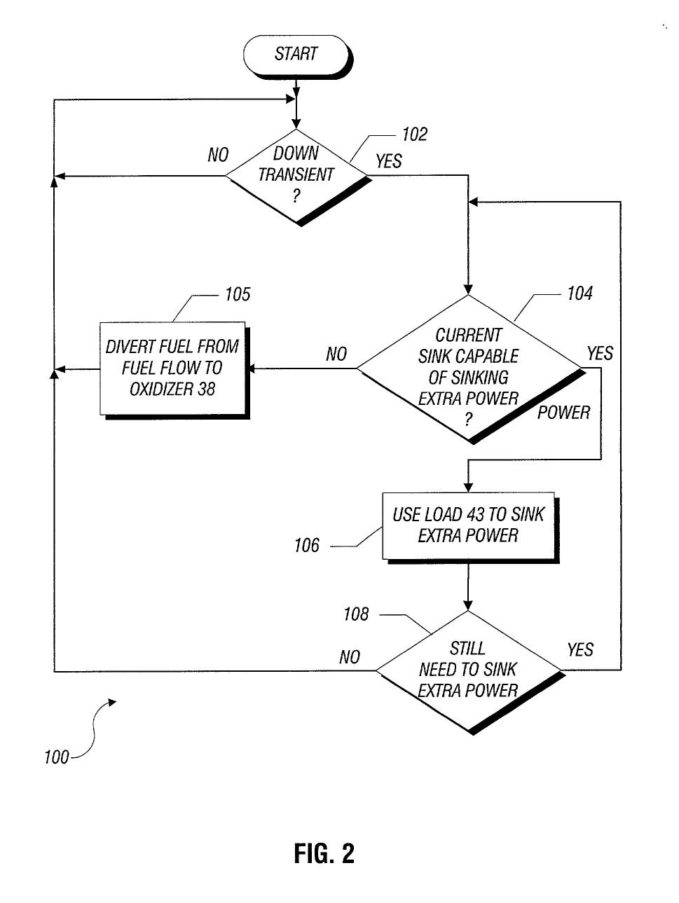

Thus, in general, the fuel cell system 10 may use a technique 100 (depicted in FIG. 2) to respond to down transients. In the technique 100, the fuel cell system 10 determines (diamond 102) whether a down transient has occurred. If not, control returns to diamond 102 until a down transient is detected. Otherwise, if a down transient has occurred, the fuel cell system 10 determines (diamond 104) whether the load 43 is capable of receiving the additional available power (i.e., additional current). For example, the load 43 may include the battery 41 (in some embodiments of the invention), a device that may be fully charged and thus, cannot receive the additional power. If this is the case, then the fuel cell system 10 diverts (block 105) fuel from the fuel flow that is received by the fuel cell stack 22 to the oxidizer 38 and control returns to diamond 102. Otherwise, if the load 43 can receive additional power, then the technique 100 includes using (block 106) the load 43 as an additional power/current sink to receive the additional power (from the fuel cell stack 20) that is no longer being consumed by the load 50 after the down transient. Subsequently, the fuel cell system 10 includes determining (diamond 108) if there is still a need to sink power that is not being consumed by the load 50. If so, control returns to diamond 104. Otherwise, control returns to diamond 102.

Referring back to FIG. 1 to describe more specific features of the fuel cell system 10, in some embodiments of the invention, the fuel cell system 10 includes a controller 60 to detect the down transients and regulate the fuel processor 22 accordingly. More particularly, in some embodiments of the invention, the controller 60 detects the down transients by monitoring the cell voltages, the terminal stack voltage (called “V_{TERM}”) and an output current (called I1) of the fuel cell stack 20. From these measurements, the controller 60 may determine when a down transient occurs.

To obtain the above-described measurements from the fuel cell stack 20, the fuel cell system 10 may include a cell voltage monitoring circuit 40 to measure the cell voltages of the fuel cell stack 20 and the VTERM stack voltage; and a current sensor 49 to measure the I1 output current. The cell voltage monitoring circuit 40 communicates (via a serial bus 48, for example) indications of the measured cell voltages to the controller 60. The current sensor 49 is coupled in series with an output terminal 31 of the fuel cell stack 20 to provide an indication of the output current (via an electrical communication line 52). With the information from the stack 20, the controller 60 may execute a program 65 (stored in a memory 63 of the controller 60) to detect a down transient and control the fuel processor 22 accordingly via electrical communication lines 46.

In some embodiments of the invention, the controller 60 builds a margin into its detection of a down transient. In this manner, the controller 60 may establish a lower threshold below the current steady state level of the power that is consumed by the load 50 and determine a down transient has occurred when the power decreases below this lower threshold. The lower threshold may be a predetermined percentage drop or an absolute below the current steady state level of the power that is consumed by the load 50, as just a few examples.

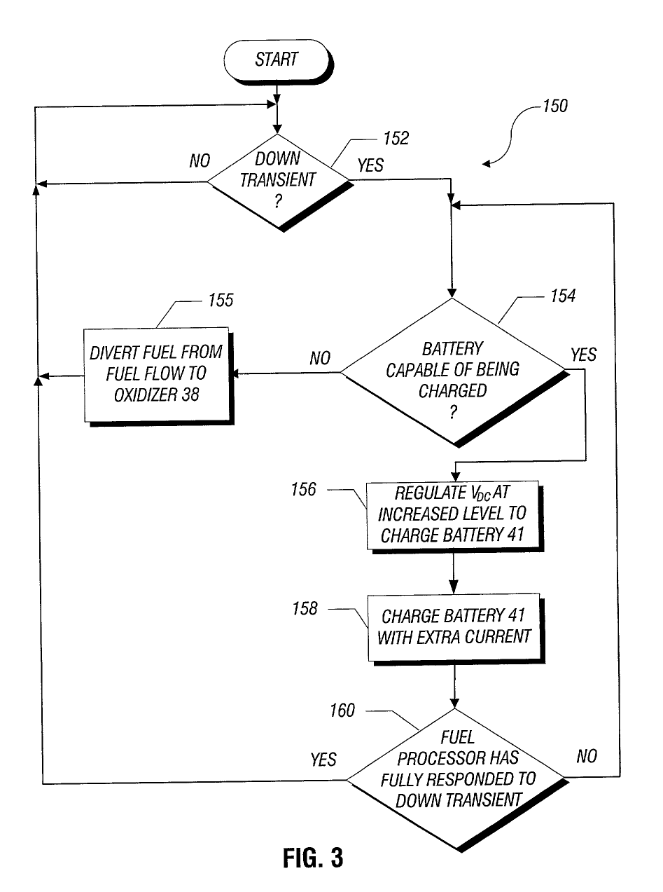

A specific implementation of the technique 100 (according to different embodiments of the invention) is described below, although other implementations are possible. Referring to FIG. 3, in some embodiments of the invention, the program 65, when executed by the controller 60, may cause the controller 60 to perform a technique 150 to regulate the I1 output current from the fuel cell stack 20 in response to down transients. In particular, the fuel cell system 20 may use the battery 41 as the load 43.

In the technique 150, the controller 60 determines (diamond 152) whether a down transient has occurred. If not, control returns to diamond 152 until a down transient is detected. Otherwise, if the controller 60 determines that a down transient has occurred, the controller 60 determines (diamond 154) whether the battery 41 is capable of being charged. To make this determination, in some embodiments of the invention, the controller 60 receives an indication (via an electrical communication line 53 (see FIG. 1)) of a terminal voltage (called VDC (see FIG. 1)) of the battery 41, and from this indication, determines whether the battery 41 can accept charge. As an example, the battery 41 may be a lead acid battery (in some embodiments of the invention) whose terminal voltage indicates a charge level of the battery 41. If the VDC voltage is above a predefined threshold, then the controller 60 considers the battery 41 to be fully charged and not capable of receiving current (called 12 (see FIG. 1)) from the fuel cell stack 20. Otherwise, the controller 60 deems that the battery 41 is capable of being charged and thus, is capable of receiving the 12 current.

Alternatively, in some embodiments of the invention, the controller 60 may monitor an amount of energy that is stored in the battery 41 when the battery 41 charges and also monitor energy that is provided by the battery 41. Therefore, by monitoring the charge into and out of the battery 41 (i.e., by monitoring the net charge remaining in the battery 41), the controller 60 may determine when the battery 41 can and cannot be charged.

Thus, if the controller 60 determines (diamond 154) that the battery 41 is not capable of receiving charge, the controller 60 diverts (block 155) fuel from the fuel flow that is received by the fuel cell stack 22 to the oxidizer 38 and control returns to diamond 152. This diversion of the fuel flow to the oxidizer 38 may be accomplished by the controller 60 actuating (via electrical communication lines 43, for example) the appropriate control valve(s) 44 to divert the flow to the oxidizer 38 via a flow line 35. Otherwise, if the battery 41 is capable of being charged, the controller 60 regulates the VDC voltage to a sufficient increased level to charge the battery 41 and cause the I2 current to flow into the battery 41 to charge the battery 41, as depicted in blocks 156 and 158.

As the battery 41 charges, the controller 60 continues to monitor the current that is consumed by the load 50 to determine (diamond 160) when the fuel processor 12 has fully responded to the down transient, i.e., to determine when the I1 current that is provided by the fuel cell stack 20 is sufficiently matched to the current consumed by the load 50 and the current consumed by parasitic elements of the fuel cell system 10. As long as this has not occurred, control returns to diamond 154 to continue charging the battery 41 (if it is still capable of receiving additional charge). Otherwise, control returns to diamond 152.

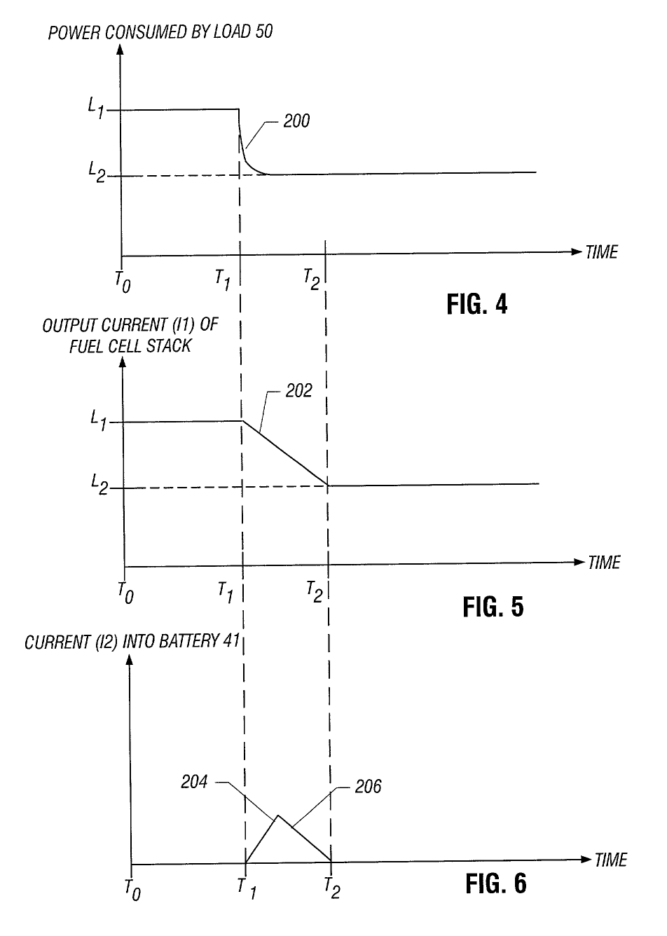

FIG. 4 depicts an exemplary time profile of power that is consumed by the load 50. In this scenario, from time T₀ to time T₁, the load 50 consumes a power near a level called L₁. At time T₁, however, the power consumed by the load 50 transitions (as indicated by the decline 200) to a new power level called L₂. The power consumed by the load 50 remains near the L₂ level for the duration of the depicted scenario.

At time T₁, the controller 60 does not control the fuel processor 22 to immediately drop its fuel production to produce the appropriate level of power to sustain the L₂ power level. Instead, the controller 60 decreases the fuel output of the fuel processor 22 at a predefined rate, as indicated by a slope 202 (see FIG. 5) at which the I1 current declines from time T₁ to time T₂, a time at which the I1 current matches the current consumed by the load 50 and the parasitic elements of the fuel cell system 10. Referring also to FIG. 6, at time T₁, the I2 current into the battery 41 sharply increases (as depicted by an increase 204) due to the charging of the battery 41 by the controller 60. From time T₁ to T₂, the I2 current decreases pursuant to a negative slope 206, as the I1 current that is produced by the fuel cell stack 20 decreases pursuant to the slope 202 (FIG. 5) during this time interval. At time T₂, the fuel processor 22 is providing a level of fuel that causes the I1 current to closely match the current that is consumed by the load 50 and the parasitic elements of the fuel cell system 10.

Referring back to FIG. 1, among the other features of the fuel cell system 20, the system 20 may include a DC-to-DC voltage regulator 30 that regulates the V_{TERM} stack voltage to produce the V_{DC} voltage. The V_{DC} voltage is converted into an AC voltage via an inverter 33 of the fuel cell system 10. The output terminals 32 of the inverter 33 are coupled to the load 50. The fuel cell system 10 also includes the control valves 44 that may be controlled by the controller 60 to divert some of the fuel flow that is received by the fuel cell stack 20 to oxidizer 38 via the flow line 35. The control valves 44 may also provide emergency shutoff of the oxidant and fuel flows to the fuel cell stack 20. The control valves 44 are coupled between inlet fuel 37 and oxidant 39 lines and the fuel and oxidant manifold inlets, respectively, to the fuel cell stack 20. The inlet fuel line 37 receives the fuel flow from the fuel processor 22, and the inlet oxidant line 39 receives the oxidant flow from the air blower 24. The fuel processor 22 receives a hydrocarbon (natural gas or propane, as examples) and converts this hydrocarbon into the fuel flow (a hydrogen flow, for example) that is provided to the fuel cell stack 20.

The fuel cell system 10 may include water separators, such as water separators 34 and 36, to recover water from the outlet and/or inlet fuel and oxidant ports of the fuel cell stack 20. The water that is collected by the water separators 34 and 36 may be routed to a water tank (not shown) of a coolant subsystem 54 of the fuel cell system 10. The coolant subsystem 54 circulates a coolant (de-ionized water, for example) through the fuel cell stack 20 to regulate the operating temperature of the stack 20. The fuel cell system 10 may also include the oxidizer 38 to bum any fuel from the stack 22 that is not consumed in the fuel cell reactions.

For purposes of isolating the load 50 from the fuel cell stack 20 during a shut down of the fuel cell system 10, the system 10 may include a switch 29 (a relay circuit, for example) that is coupled between the main output terminal 31 of the stack 20 and an input terminal of the current sensing element 49. The controller 60 may control the switch 29 via an electrical communication line 51.

In some embodiments of the invention, the controller 60 may include a microcontroller and/or a microprocessor to perform one or more of the techniques that are described herein when executing the program 65. For example, the controller 60 may include a microcontroller that includes a read only memory (ROM) that serves as the memory 63 and a storage medium to store instructions for the program 65. Other types of storage mediums may be used to store instructions of the program 65. Various analog and digital external pins of the microcontroller may be used to establish communication over the electrical communication lines 47, 46, 51 and 52 and the serial bus 48. In other embodiments of the invention, a memory that is fabricated on a separate die from the microcontroller may be used as the memory 63 and store instructions for the program 65. Other variations are possible.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
providing a fuel flow to the fuel cell stack to produce power; at least some of the power being consumed by a first load;
in response to a decrease in at least one of the power produced by the fuel cell stack and the power consumed by the first load, determining whether to route at least some of the power produced by the fuel cell stack and not consumed by the first load to a second load; and
based on the determination, selectively routing said at least some of the power produced by the fuel cell stack and not consumed by the first load to the second load.

2. The method of claim 1, wherein the determining comprises:
determining whether the second load is capable of receiving said at least some of the power produced by the fuel cell stack and not consumed by the first load.

3. The method of claim 1, wherein
the second load comprises a battery; and
the determining comprises determining whether the battery is capable of being charged using said power produced by the fuel cell stack and not consumed by the first load.

4. The method of claim 1, wherein
the second load comprises a battery; and
the selectively routing comprises selectively charging the battery based on the determination.

5. The method of claim 4, wherein the charging comprises regulating a terminal voltage of the battery to cause the battery to charge.

6. The method of claim 1, further comprising:
decreasing the fuel flow in response to the detection of the decrease.

7. The method of claim 6, wherein the routing occurs until the fuel flow is decreased to a level at which the power routed to the load is approximately zero.

8. The method of claim 1, wherein
the providing comprises operating a fuel processor to provide the fuel flow.

9. A system comprising:
a first load;
a second load;
a fuel processor to provide a fuel flow;
a fuel cell stack coupled to the first load and adapted to provide a power in response to the fuel flow, at least some of the power being consumed by the first load; and
a circuit adapted to:
in response to a decrease in the power produced by the fuel cell stack and consumed by the first load, determine whether to route at least some of the power produced by the fuel cell stack and not consumed by the first load to the second load, and
based on the determination, selectively route said at least some of the power produced by the fuel cell stack and not consumed by the first load to the second load.

10. The system of claim 9, wherein the circuit determines whether the second load is capable of receiving said at least some of the power produced by the fuel cell stack and not consumed by the first load.

11. The system of claim 9, wherein the circuit comprises a controller.

12. The system of claim 9, wherein
the second load comprises a battery; and
the circuit is adapted to determine whether the battery is capable of being charged using said power produced by the fuel cell stack and not consumed by the first load.

13. The system of claim 12, wherein the circuit determines whether the battery is capable of being charged by examining a terminal voltage of the battery.

14. The system of claim 9, wherein
the second load comprises a battery; and
the circuit is adapted to selectively charge the battery based on the determination.

15. The system of claim 14, further comprising:
a voltage regulator coupled between the fuel cell stack and the second load to provide a voltage across terminals of the battery,
wherein the circuit is adapted to interact with the voltage regulator to adjust the voltage to cause the battery to charge.

16. The system of claim 9, wherein the circuit is adapted to decrease the fuel flow in response to the detection of the decrease.

17. The system of claim 16, wherein the circuit is adapted to decrease the fuel flow at a rate that does not exceed a predefined rate.

18. The system of claim 17, wherein the circuit routes said at least some of the power produced by the fuel cell stack and not consumed by the first load to the second load until the fuel flow is decreased to a level at which the power routed to the first load is approximately zero.
